(19) United States
(12) Patent Application Publication
(10) Pub. No.: US 2024/0095640 A1
(43) Pub. Date: Mar. 21, 2024

(54) ENERGY COST REDUCTION OF METAVERSE OPERATIONS

(71) Applicant: ACCENTURE GLOBAL SOLUTIONS LIMITED, Dublin 4 (IE)

(72) Inventors: Janardan MISRA, Bangalore (IN); Sanjay PODDER, Thane (IN)

(73) Assignee: ACCENTURE GLOBAL SOLUTIONS LIMITED, Dublin 4 (IE)

(21) Appl. No.: 17/942,875

(22) Filed: Sep. 12, 2022

(51) Int. Cl. G06Q 10/06

(52) U.S. Cl. CPC G06Q 10/06375; G06Q 10/067

(57) ABSTRACT

In some examples, energy cost reduction of metaverse operations may include generating a unified model of What-IF scenarios. For a semantic association graph of organization avatar entities and for each logically independent IF scenario of a plurality of logically independent IF scenarios of the What-IF scenarios, a sub-metaverse of semantically connected organization avatar entities may be determined. State transitions of the semantically connected organization avatar entities may be iteratively performed until the sub-metaverse reaches a stationarily stable state or an operating limit. A determination may be made as to whether a goal condition is met in the sub-metaverse. For each of the logically independent IF scenarios for which the goal condition is met, an overall energy cost may be determined, and a logically independent IF scenario that includes a minimum energy cost may be identified and used to control an operation for an organization entity.

### BACKGROUND

A metaverse may be described as a hypothetical immersive virtual world. The metaverse may utilize a variety of technologies such as virtual reality (VR), augmented reality (AR), artificial intelligence, machine learning, etc., to provide an immersive experience. The metaverse may be used to analyze a variety of real world concepts in a virtual world.

### BRIEF DESCRIPTION OF DRAWINGS

Features of the present disclosure are illustrated by way of example and not limited in the following figure(s), in which like numerals indicate like elements, in which:

FIG. 1 illustrates a layout of an energy cost reduction of metaverse operations apparatus in accordance with an example of the present disclosure;

FIG. 2 illustrates an architecture of the energy cost reduction of metaverse operations apparatus of FIG. 1, in accordance with an example of the present disclosure;

FIG. 3 illustrates organization avatar entities to illustrate operation of the energy cost reduction of metaverse operations apparatus of FIG. 1, in accordance with an example of the present disclosure;

FIG. 4 illustrates a semantic association graph of the organization avatar entities of FIG. 3 to illustrate operation of the energy cost reduction of metaverse operations apparatus of FIG. 1, in accordance with an example of the present disclosure;

FIG. 5 illustrates a sub-metaverse of semantically connected organization avatar entities to illustrate operation of the energy cost reduction of metaverse operations apparatus of FIG. 1, in accordance with an example of the present disclosure;

FIG. 6 illustrates state transitions of semantically connected organization avatar entities to illustrate operation of the energy cost reduction of metaverse operations apparatus of FIG. 1, in accordance with an example of the present disclosure;

FIG. 7 illustrates avatar entity details to illustrate operation of the energy cost reduction of metaverse operations apparatus of FIG. 1, in accordance with an example of the present disclosure;

FIG. 8 illustrates state transition details to illustrate operation of the energy cost reduction of metaverse operations apparatus of FIG. 1, in accordance with an example of the present disclosure;

FIG. 9 illustrates an example block diagram for energy cost reduction of metaverse operations in accordance with an example of the present disclosure;

FIG. 10 illustrates a flowchart of an example method for energy cost reduction of metaverse operations in accordance with an example of the present disclosure; and

FIG. 11 illustrates a further example block diagram for energy cost reduction of metaverse operations in accordance with another example of the present disclosure.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Energy cost reduction of metaverse operations apparatuses, methods for energy cost reduction of metaverse operations, and non-transitory computer readable media having stored thereon machine readable instructions to provide energy cost reduction of metaverse operations are disclosed herein. The apparatuses, methods, and non-transitory computer readable media disclosed herein provide for an automated technique with minimal energy cost for simulating simultaneous evolution of avatar entities by creating a sub-metaverse and observing asymptotically stationary states of this sub-metaverse. A metaverse may represent a collective virtual shared space. The shared space may be created, for example, by a combination of physically persistent virtual space and virtually enhanced physical reality. In this regard, the term environmental social and governance (ESG) as utilized herein may refer to the factors of environment, social, and governance that are used to measure sustainability. For the apparatuses, methods, and non-transitory computer readable media disclosed herein, observance of asymptotically stationary states of the sub-metaverse may be utilized to determine optimal enabling scenarios to reach a specified goal state with minimum energy cost, while maintaining bounding limits on energy usage. In this regard, the apparatuses, methods, and non-transitory computer readable media disclosed herein may address a technical problem of implementing a goal analyzer that operates in the metaverse for optimizing energy cost to decide feasibility of transitioning to a goal state within bounded limits for avatar entities under different enabling scenarios.

The apparatuses, methods, and non-transitory computer readable media disclosed herein further provide for the design of the goal analyzer for what-if (hereinafter “What-IF”) scenario analysis in the metaverse. The apparatuses, methods, and non-transitory computer readable media disclosed herein provide for an automated technique for simulating evolution of avatar entities by creating a mini-metaverse and determining a status of an expected objective in stationary states of this mini-metaverse.

With respect to energy cost reduction of metaverse operations as disclosed herein, it is technically challenging to analyze What-IF scenarios in an ESG domain due to complexities involved in accurately modelling organizations and their operating environments. A metaverse may render the simulation of such What-IF scenarios feasible because of the existence of digital avatars for organization entities (e.g., business entities) and their operating environments as programmable computational models with unique digital identities. These avatars may represent digital representations of organizations and computational models of their operating environments.

The apparatuses, methods, and non-transitory computer readable media disclosed herein address the aforementioned technical challenges by implementation of a scenario simulator that simulates evolution of specific ESG avatar entities under laws governing interactions between these avatar entities and their operating environments. Such simulated evolution of a sub-metaverse, comprising of those ESG avatar entities as specified by a What-IF scenario, may provide for analysis of eventual states in which actual organizations may enter in-case a What-IF scenario becomes realistic.

For the apparatuses, methods, and non-transitory computer readable media disclosed herein, a What-IF analysis process as disclosed herein may be implemented by first building a unified model of What-IF scenarios. In this regard, the apparatuses, methods, and non-transitory computer readable media disclosed herein may logically unify IF scenarios, and identify logically independent scenarios.

Next, the apparatuses, methods, and non-transitory computer readable media disclosed herein may include building of a semantic association graph of organization avatar entities. In this regard, for each logically independent and unified IF scenario, the following operations specified as [I]-[V] may be executed collaboratively.

For operation [I], the apparatuses, methods, and non-transitory computer readable media disclosed herein may provide for determination of a space of semantically connected avatar entities, which may potentially participate in the simulation (e.g., What-IF sub-metaverse). For operation [II], the apparatuses, methods, and non-transitory computer readable media disclosed herein may iteratively perform state transitions of enabled entities until the sub-metaverse reaches a stationarily stable state or operating limit. For operation [III], the apparatuses, methods, and non-transitory computer readable media disclosed herein may provide for determination of whether an IF goal condition holds in the sub-metaverse in its stable state. For operation [IV], if True, α, β, and γ may be counted as follows:
α=Number of state transitions to reach goal state
β=Sizes of encodings of transition enabling conditions evaluated while reaching goal state
γ=Number of operations executed involving state variables during transitions Next, the apparatuses, methods, and non-transitory computer readable media disclosed herein may estimate energy cost in terms of (α, β, and γ). Thereafter, the apparatuses, methods, and non-transitory computer readable media disclosed herein may select, among all of the unified and logically independent IF scenarios for which a goal state was reachable, one scenario with minimum Energy (Δ). Next, If (Δ≤bounding limit), the apparatuses, methods, and non-transitory computer readable media disclosed herein may perform the following operations:

Set M={Goal State Reachable=True,A}

Else Set M={Goal State Reachable=False,A}
Communicate M to the ESG operating environment in the metaverse.

The apparatuses, methods, and non-transitory computer readable media disclosed herein may further provide technical improvements such as reduction in computational resources (e.g., processor time, network bandwidth, and energy) that are needed to determine if a set of scenarios (e.g., IF-conditions as disclosed herein) will result in a desired goal (e.g., WHAT as disclosed herein) for computational models of organization entities. For example, the apparatuses, methods, and non-transitory computer readable media disclosed herein may provide a technical solution of minimizing energy requirements for deciding whether an IF scenario should be applied at all or not (e.g., in the future), and such application would be performed by the operating environment based upon the actual occurrence of the IF Scenario in future. In this regard, the energy savings may be quantified as disclosed herein to provide an implementation of the apparatuses, methods, and non-transitory computer readable media disclosed herein. The apparatuses, methods, and non-transitory computer readable media disclosed herein may also add precision with respect to sub-metaverse generation based upon simulation strategies.

For the apparatuses, methods, and non-transitory computer readable media disclosed herein, the elements of the apparatuses, methods, and non-transitory computer readable media disclosed herein may be any combination of hardware and programming to implement the functionalities of the respective elements. In some examples described herein, the combinations of hardware and programming may be implemented in a number of different ways. For example, the programming for the elements may be processor executable instructions stored on a non-transitory machine-readable storage medium and the hardware for the elements may include a processing resource to execute those instructions. In these examples, a computing device implementing such elements may include the machine-readable storage medium storing the instructions and the processing resource to execute the instructions, or the machine-readable storage medium may be separately stored and accessible by the computing device and the processing resource. In some examples, some elements may be implemented in circuitry.

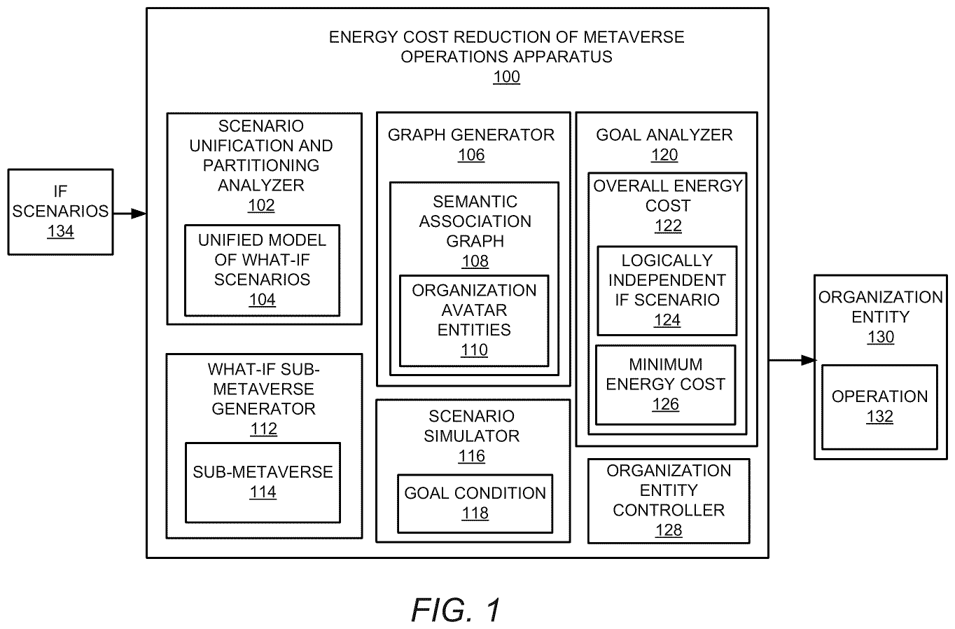

FIG. 1 illustrates a layout of an example energy cost reduction of metaverse operations apparatus (hereinafter also referred to as “apparatus 100”).

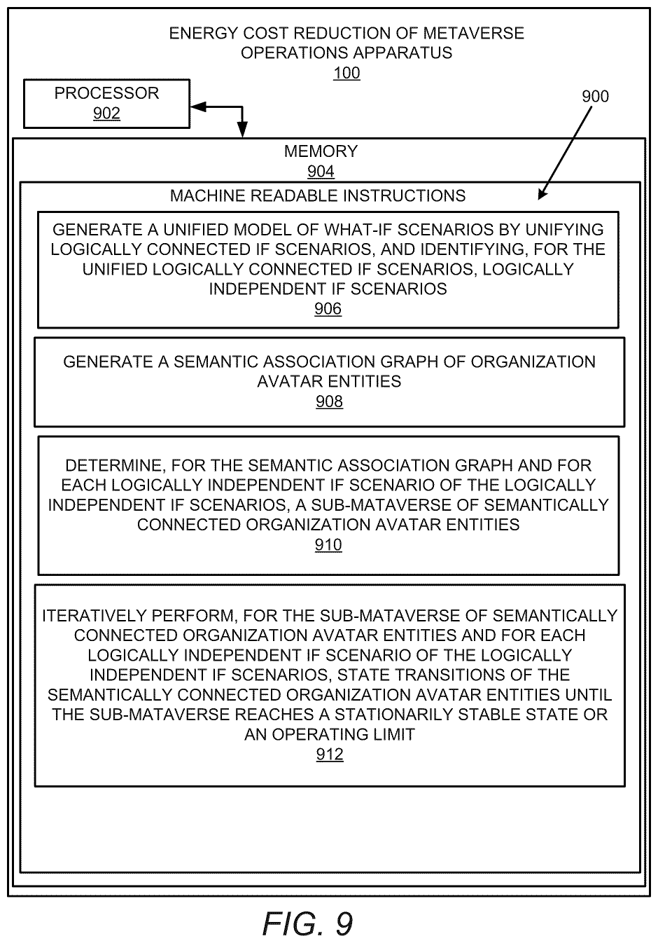

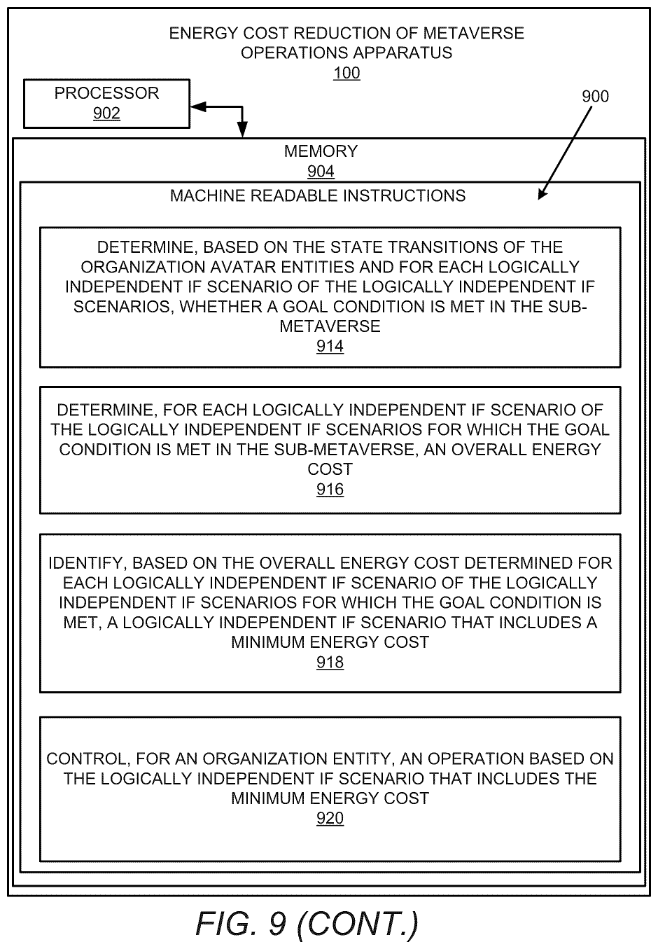

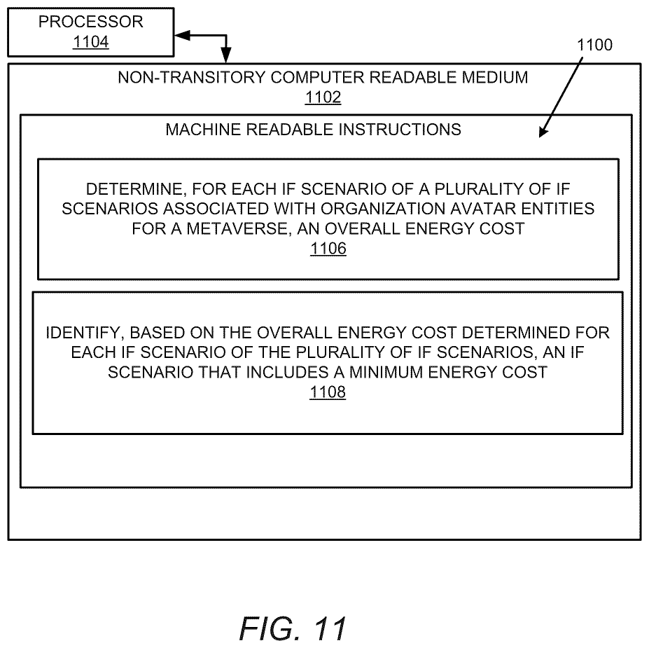

Referring to FIG. 1, the apparatus 100 may include a scenario unification and partitioning analyzer 102 that is executed by at least one hardware processor (e.g., the hardware processor 902 of FIG. 9, and/or the hardware processor 1104 of FIG. 11) to generate a unified model of What-IF scenarios 104 by unifying logically connected IF scenarios (e.g., from an input including IF scenarios 134), and identifying, for the unified logically connected IF scenarios, logically independent IF scenarios. An example of the logically independent IF scenarios is as follows:

### IF Scenarios:

IF Scenario 1: IF (RainDepth<12 mm)
IF Scenario 2: IF (RainDepth<8 mm)
IF Scenario 3: IF (SupplyRaw<4000 AND SupplyRaw>=2500)
IF Scenario 4: IF (SupplyRaw<5000 AND SupplyRaw>=3500)
   IF Scenario 1 and IF Scenario 2 get unified into
Unified Scenario 1: IF (RainDepth<8 mm)
   IF Scenario 3 and IF Scenario 4 get unified into
Unified Scenario 2: IF (SupplyRaw<4000 AND SupplyRaw>=3500)
   Unified Scenario 1 and Unified Scenario 2 are logically independent.

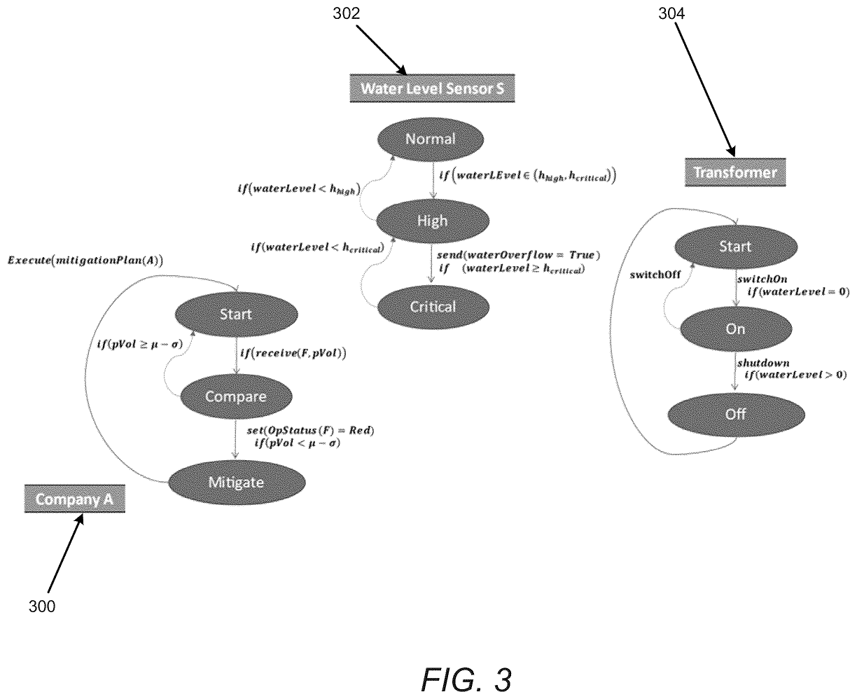

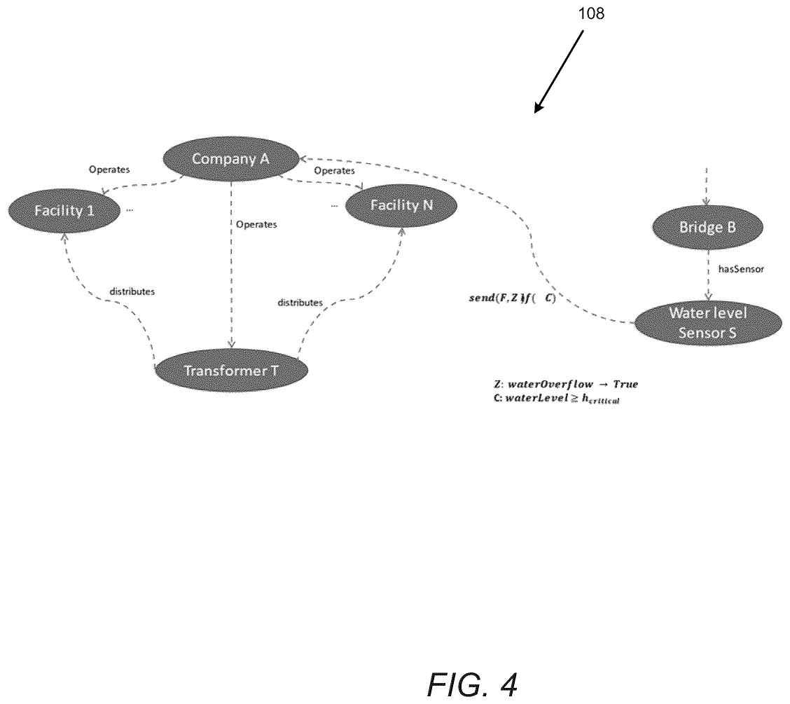

A graph generator 106 that is executed by at least one hardware processor (e.g., the hardware processor 902 of FIG. 9, and/or the hardware processor 1104 of FIG. 11) may generate a semantic association graph 108 of organization avatar entities 110. In this regard, FIG. 3 illustrates organization avatar entities to illustrate operation of the apparatus 100, in accordance with an example of the present disclosure. Further, FIG. 4 illustrates a semantic association graph of the organization avatar entities of FIG. 3 to illustrate operation of the apparatus 100, in accordance with an example of the present disclosure. Referring to FIG. 3, examples of the organization avatar entities 110 may be specified as follows:
Avatar Entity #1: Company A (e.g., at 300) executing production operations using electricity. Company A is located close to a river.
Avatar Entity #2: There is a bridge over the river with depth sensor S (e.g., at 302).
Avatar Entity #3: Power transformer (e.g., at 304) giving electrical supply to Company A
   The semantic association graph 108 (e.g., state transition graph) for the organization avatar entities 110 of FIG. 3 is shown in FIG. 4.

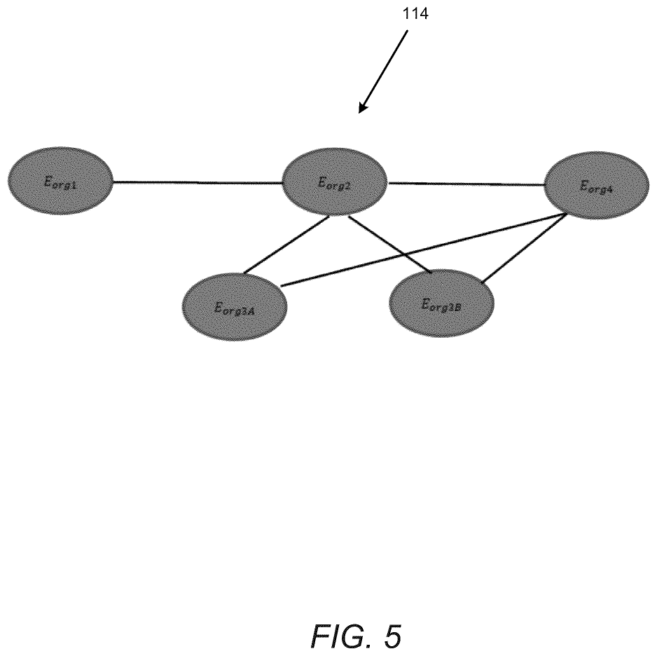

A What-IF sub-metaverse generator 112 that is executed by at least one hardware processor (e.g., the hardware processor 902 of FIG. 9, and/or the hardware processor 1104 of FIG. 11) may determine, for the semantic association graph 108 and for each logically independent IF scenario of the logically independent IF scenarios, a sub-metaverse 114 of semantically connected organization avatar entities. In this regard, FIG. 5 illustrates a sub-metaverse of semantically connected organization avatar entities to illustrate operation of the apparatus 100, in accordance with an example of the present disclosure. For example, FIG. 5 illustrates organization avatar entities for five organizations as follows:
E_{org1}: Entity representing organization 1, which supplies raw materials
E_{org2}: Entity representing organization 2, which designs and manufactures market products
E_{org3A}: Entity representing organization 3 that distributes products in geography A
E_{org3B}: Entity representing organization 4 that distributes products in geography B
E_{org4}: Entity representing a governmental organization 5 that formulates compliance regulations
   In FIG. 5, the sub-metaverse 114 shows the connections between the organization avatar entities.

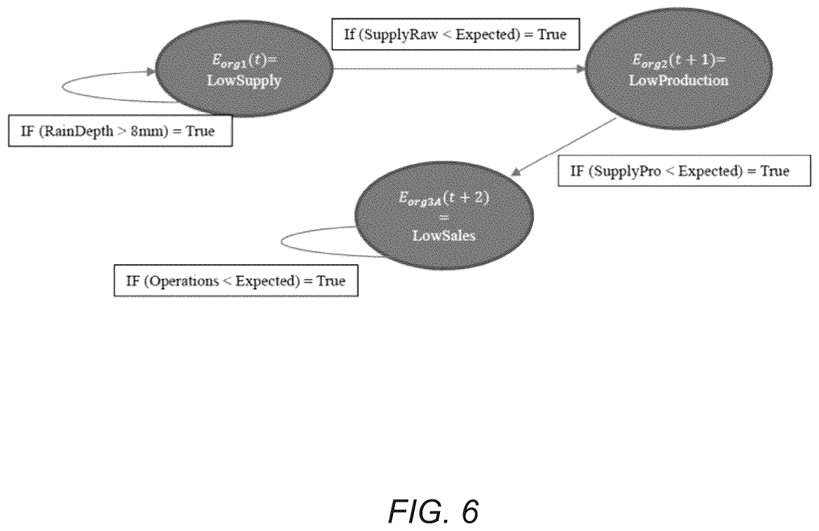

A scenario simulator 116 that is executed by at least one hardware processor (e.g., the hardware processor 902 of FIG. 9, and/or the hardware processor 1104 of FIG. 11) may iteratively perform, for the sub-metaverse 114 of semantically connected organization avatar entities and for each logically independent IF scenario of the logically independent IF scenarios, state transitions of the semantically connected organization avatar entities until the sub-metaverse reaches a stationarily stable state or an operating limit. In this regard, FIG. 6 illustrates state transitions of semantically connected organization avatar entities to illustrate operation of the apparatus 100, in accordance with an example of the present disclosure. The scenario simulator 116 may determine, based on the state transitions of the organization avatar entities and for each logically independent IF scenario of the logically independent IF scenarios, whether a goal condition 118 is met in the sub-metaverse 114. In this regard, for goal condition IF (Sales≥μ−σ), this goal condition specifies if sale of the product would decrease by one standard deviation from the average sale of previous years.

A goal analyzer 120 that is executed by at least one hardware processor (e.g., the hardware processor 902 of FIG. 9, and/or the hardware processor 1104 of FIG. 11) may determine, for each logically independent IF scenario of the logically independent IF scenarios for which the goal condition 118 is met in the sub-metaverse 114, an overall energy cost 122. The goal analyzer 120 may identify, based on the overall energy cost 122 determined for each logically independent IF scenario of the logically independent IF scenarios for which the goal condition 118 is met, a logically independent IF scenario 124 that includes a minimum energy cost 126.

An organization entity controller 128 that is executed by at least one hardware processor (e.g., the hardware processor 902 of FIG. 9, and/or the hardware processor 1104 of FIG. 11) may control, for an organization entity 130, an operation 132 based on the logically independent IF scenario 124 that includes the minimum energy cost 126.

According to examples disclosed herein, the goal analyzer 120 may determine, for each logically independent IF scenario of the logically independent IF scenarios for which the goal condition 118 is met in the sub-metaverse 114, a number of state transitions to reach a goal state. In this regard, with reference to FIG. 6, the state transitions may be reached by the following enabling conditions:
1. IF (RainDepth>8 mm)=True for entity E_{org1} at time-point t by transitioning it to state=LowSupply
2. If (SupplyRaw<Expected)=True for entity E_{org2} at time-point t+1 by transitioning it to state=LowProduction
3. IF (SupplyPro<Expected)=True for entity E_{org3A} at time-point t+2 by transitioning it to state=LowSales
   In state LowSales goal condition IF (Sales≥μ−σ) is True.

According to examples disclosed herein, the goal analyzer 120 may determine, for each logically independent IF scenario of the logically independent IF scenarios for which the goal condition 118 is met in the sub-metaverse 114, sizes of encodings of transition enabling conditions. In this regard, each condition may be a Boolean logical formula that can be represented as a string of characters, for example, in American Standard Code for Information Interchange (ASCII) or using some other scheme by the design environment. A number of atomic units (e.g., characters in ASCII) may be used to represent a condition by its size. For example, size of condition If(SupplyRaw<Expected) when represented as a character string is 22.

According to examples disclosed herein, the goal analyzer 120 may determine, for each logically independent IF scenario of the logically independent IF scenarios for which the goal condition 118 is met in the sub-metaverse 114, a number of operations that involve state variables during transitions to reach a goal state. For the example of FIG. 6, a number of operations that involve state variables during transitions to reach a goal state are 11.

According to examples disclosed herein, the scenario unification and partitioning analyzer 102 may identify, for the unified logically connected IF scenarios, logically independent IF scenarios by retaining, from each cluster of a plurality of clusters of the unified logically connected IF scenarios, a single IF scenario.

According to examples disclosed herein, the goal analyzer 120 may determine, for each logically independent IF scenario of the logically independent IF scenarios for which the goal condition 118 is met in the sub-metaverse 114, the overall energy cost 122 as a function of energy emission of executing a state transition, energy emission of determining logical validity of a state transition enabling condition, and/or energy emission of assigning a value to an output state variable. Examples of these three types of energy emissions may be specified as follows:
Energy emission of executing a state transition=50 (number of state transitions)×3 Kw (energy emission of each state transition assuming each transition emitting exactly the same amount of energy)=150 Kw.
Energy emission of determining logical validity of a state transition enabling condition=50 (number of state transitions)×1.2 Kw (energy emission of determining logical validity of a state transition enabling condition assuming that energy consumption for each is the same)=60 Kw.
Energy emission of assigning a value to an output state variable=70 (number of variable assignments)×0.1 Kw (energy emission of each assignment)=7 Kw.

According to examples disclosed herein, the goal analyzer 120 may compare the minimum energy cost 126 to a bounding limit. Further, based on a determination that the minimum energy cost 126 is less than the bounding limit, the goal analyzer 120 may identify the logically independent IF scenario as including the minimum energy cost 126 that is less than the bounding limit. An example of a minimum energy emission may be specified as 500 Kw (Kilo watt), with a bounding limit of 600 Kw.

According to examples disclosed herein, the goal analyzer 120 may compare the minimum energy cost 126 to a bounding limit. Further, based on a determination that the minimum energy cost 126 is greater than the bounding limit, the goal analyzer 120 may identify the logically independent IF scenario as including the minimum energy cost 126 that is greater than the bounding limit.

Operation of the apparatus 100 is described in further detail with reference to FIGS. 1-8.

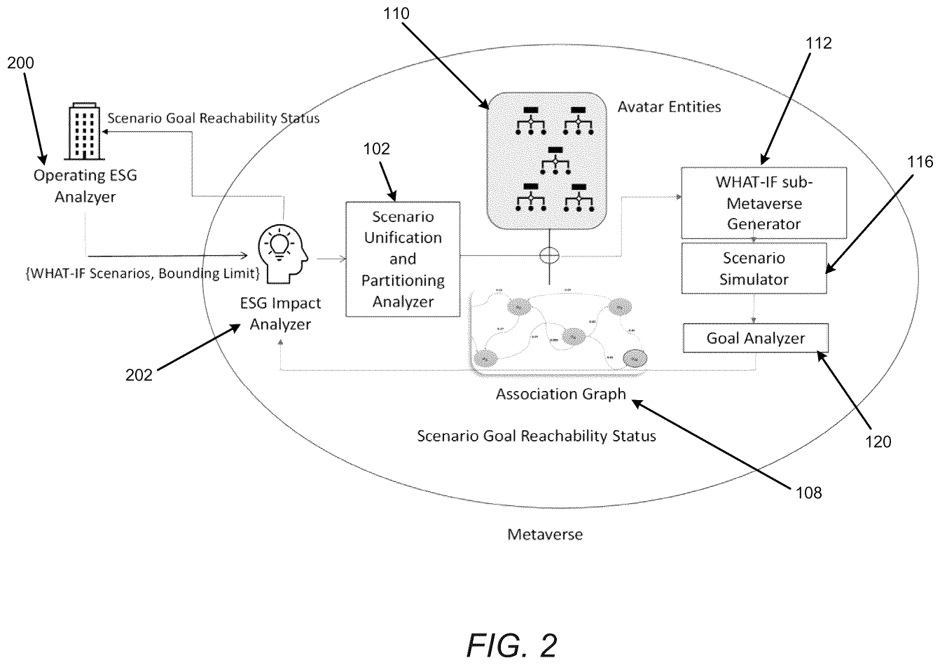

FIG. 2 illustrates an architecture of the energy cost reduction of metaverse operations apparatus 100, in accordance with an example of the present disclosure

Referring to FIGS. 1 and 2, the metaverse may represent a computational process with sub-processes specified as follows:

ESGₘₑₜₐ=[{ [symbol] a₁,a₁(t),act(⋅),envₐ_{₁} [symbol] , . . . , [symbol] aₙ,aₙ(t),act(⋅),envₐ_{ₙ} [symbol] },env_{G}] Equation (1)

For Equation (1), χ=a₁, . . . , aₙ, may represent a set of models emulating organization entities—referred to hereinafter as organization avatar (OAv) entities. Further, for Equation (1), aᵢ(t), act(aᵢ, t), envₐ_{ᵢ}, and env_{G} may be described as follows:
aᵢ(t): State of OAv entity aᵢ at time point t
act(aᵢ,t): Set of actions, which OAv entity aᵢ may execute in state aᵢ(t) at timepoint t
envₐ_{ᵢ}: Operating environment of OAv entity aᵢ including its semantically connected neighboring entities and plausible actions which the semantically connected neighboring entities can perform in association with aᵢ
env_{G}: Global environment consisting of external entities, which can interact with entities in χ and plausible actions which the external entities can perform in association with entities in χ

With respect to state transition graphs as computational models of organization entities, computationally, each organization avatar entity in the metaverse may be modelled as a state transition graph. A state transition graph may specify in which state an entity currently is, and would transition from a current state to when transition conditions are enabled.

Operating ESG analyzer 200 may communicate What-IF scenarios and a bounding limit to ESG impact analyzer 202.

The ESG impact analyzer 202 may communicate What-IF scenarios and the bounding limit to scenario unification and partitioning analyzer 102. At the completion of the analysis, the ESG impact analyzer 202 may receive a scenario goal reachability status from the goal analyzer 120 and communicate it back to the operating ESG analyzer 200.

With respect to nodes representing states of organization avatar entities (OAE), states of OAEs may be characterized by input state variables that hold values of observable characteristics of OAEs, and output state variables that hold values of outputs produced by OAEs while performing transitions. A directed edge u→^{c}v may represent that if an OAE is in state u, the OAE would transit to state v if condition c holds in state u. Each transition condition c may represent a Boolean logic formula over input state variables and specify which states an OAE may transit to from a current state.

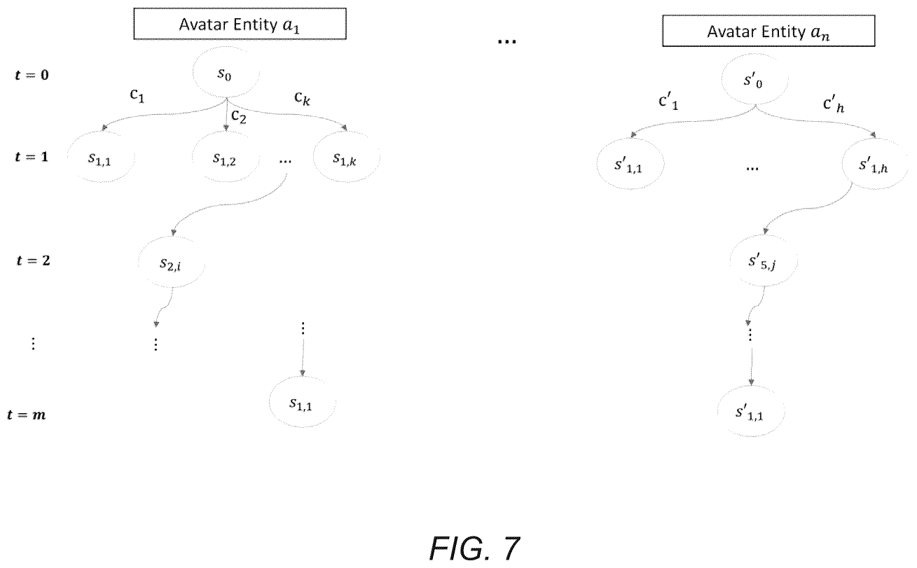

FIG. 7 illustrates avatar entity details to illustrate operation of the energy cost reduction of metaverse operations apparatus 100, in accordance with an example of the present disclosure. In FIG. 7, both of the graphs depict state transition diagrams of different organization avatar entities 110. Both of the graphs differ in their states s₀ versus s′₀, s_{1,k} versus s′_{1,h}, etc. In each state, different organization avatar entities 110 have a different number of state transitions. For example, for entity a₁, state s₀ has k transitions whereas for entity aₙ, state s′₀ has h transitions. Enabling conditions for transitions for both entities are different, for example, from state s₀, entity a₁ has enabling conditions as c₁, . . . , cₖ, whereas from state s′₀, entity aₙ has enabling conditions as c′₁, . . . , c′ₕ.

Referring to FIGS. 1 and 7, with respect to a computational model of a What-IF scenario, What-IF scenarios may be specified by scenario constraints, scenario goal, and scenario strategy. With respect to scenario constraints C_{if}={c₁, . . . cₙ}, the scenario constraints may represent a set of constraints specifying different initial scenarios. Each scenario constraint cᵢ (e.g., scenario constraints c₁, c₂, . . . , cₖ, and c′₁, . . . , c′ₕ, shown in FIG. 7) may be a Boolean logic formula over input state variables of one or more OAEs. With respect to scenario goal g_{what}, the scenario goal may specify an objective of the What-IF scenarios. The scenario goal g_{what} may also be expressed as a Boolean logic formula with respect to output state variables of OAEs.

A simulation strategy may specify a space of exploration while simulating the What-IF scenario. Simulation strategies may include minimal that specifies that only highly likely interactions among OAEs should be considered, maximal that specifies that all likely interactions among OAEs should be considered, and expected that specifies that only interactions among strongly associated OAEs should be considered.

With respect to a computational model of the scenario unification and partitioning analyzer 102, the scenario unification and partitioning analyzer 102 may generate a unified model of What-IF scenarios by unifying logically connected IF scenarios and thereafter identifying independent scenarios. An input to the scenario unification and partitioning analyzer 102 may include scenario constraints C_{if}={c₁, . . . cₙ}. A computational process implemented by the scenario unification and partitioning analyzer 102 may execute steps [1]-[5] as described below. The steps [1]-[5] and additional steps described below are specified to facilitate a description of operation of the apparatus 100, and not to limit the scope of operation of the apparatus 100 to the specified steps, which may be different than the order specified for the steps described below, or which may eliminate one or more of the steps described below.

With respect to scenario partitioning, step [1] executed by the scenario unification and partitioning analyzer 102 may include identifying logically equivalent scenarios. In this regard, scenario constraints c₁ and c₂ are logically equivalent if:

c₁⇒c₂ AND c₂⇒c₁ Equation (2)

For Equation (2), ⇒ represents logical implication.

With respect to scenario partitioning, step [2] executed by the scenario unification and partitioning analyzer 102 may include partitioning C_{if} into sets of logically equivalent scenarios:

C_{if}=C₁∪ . . . ∪Cₖ

for all j≠l:Cⱼ∩Cₗ=Ø Equation (3)

For Equation (3), each set Cⱼ⊆C_{if} may include scenario constraints that are all logically equivalent.

With respect to scenario partitioning, step [3] executed by the scenario unification and partitioning analyzer 102 may include deleting, from each set Cⱼ, all but one of the scenario constraints. In this regard, cⱼ∈Cⱼ may be specified as the retained scenario constraint in the set Cⱼ. After elimination of logically equivalent scenario constraints, the reduced set of scenarios may be specified as follows:

C_{if}⁻={c₁, . . . ,cₖ}⊆C_{if} Equation (4)

With respect to scenario partitioning, step [4] executed by the scenario unification and partitioning analyzer 102 may include eliminating logically subsumed scenarios by identifying pairs of scenario constraints c_{g} and cₕ in C_{if}⁻ such that c_{g} is subsumed by cₕ. A scenario constraint of the form (X AND Y⇒Z) may be subsumed by scenario constraints (X⇒Z) as well as (Y⇒Z). Further, scenario constraints (X⇒Z) and (Y⇒Z) in C_{if}⁻ may be subsumed by scenario constraint (X OR Y⇒Z).

With respect to scenario partitioning, step [5] executed by the scenario unification and partitioning analyzer 102 may include eliminating logically subsumed scenarios by iteratively removing all of those scenario constraints from the set C_{if}⁻ that are subsumed by any other scenario constraints. At the end of this iterative process, logically independent scenario constraints may remain in C_{if}⁻.

Next, with respect to a computational model of the What-IF sub-metaverse generator 112, for cluster generation, for a next step (e.g., step [6]), the What-IF sub-metaverse generator 112 may partition the semantic association graph 108 into semantically unrelated clusters of OAEs. The sub-metaverse may identify maximal connected components in the resulting semantic association graph 108 (also referred to as “entity association graph”). A connected component in the semantic association graph 108 may represent a group of nodes such that association of every node with every other node may be determined by following one or more edges. A maximal connected component may represent a connected component that is not contained in any other connected component in a graph.

With respect to What-IF sub-metaverse generation, for each of the independent unified scenario constraints c∈C_{if}⁻, the What-IF sub-metaverse generator 112 may create a sub-metaverse by limiting that metaverse to those organization avatar entities that are likely to be impacted by an IF scenario. This may avoid the need to obtain a copy of the entire metaverse for simulation, which may be computationally prohibitive.

With respect to a computational model of the What-IF sub-metaverse generator 112, for What-IF sub-metaverse generation, for a next step (e.g., step [7]), the What-IF sub-metaverse generator 112 may determine all those OAEs for which IF scenario constraint c is satisfied in their current states. In this regard, mMetaᵢₙᵢ may represent a set of OAEs satisfying the IF scenario constraint.

With respect to a computational model of the What-IF sub-metaverse generator 112, for What-IF sub-metaverse generation, for a next step (e.g., step [8]), the What-IF sub-metaverse generator 112 may generate a sub-metaverse as per the simulation strategy specified by the operating environment. In this regard, if the simulation strategy=exact, the What-IF sub-metaverse generator 112 may include all of the OAEs that are reachable by following one or more associations of strengths≥γ from any OAE in mMetaᵢₙᵢ within their own clusters. In this regard, whatifMetaₘᵢₙᵢ may represent a set of OAEs y-reachable from any OAE in mMetaᵢₙᵢ.

If the simulation strategy is equal to maximal, the What-IF sub-metaverse generator 112 may include all of the OAEs that are reachable by following one or more associations from any of the OAEs in mMetaᵢₙᵢ within their own clusters. In this regard, whatifMetaₘᵢₙᵢ may represent a set of OAEs reachable from any OAE in mMetaᵢₙᵢ.

Alternatively, if the simulation strategy is equal to minimal, the What-IF sub-metaverse generator 112 may include all of the OAEs that are reachable by following one or more associations from every OAE in mMetaᵢₙᵢ within their own clusters. In this regard, whatifMetaₘᵢₙᵢ may represent a set of OAEs reachable from every mMetaᵢₙᵢ.

Next, with respect to the computational model of the scenario simulator 116, the scenario simulator 116 may iteratively perform state transitions of enabled entities until one of the following three simulation termination conditions hold. With respect to a goal condition c_{g}, after current state transitions, a scenario goal g_{whatif} may hold over the observed output state variables. A stationarity condition cₛ may occur when a What-IF sub-metaverse reaches a stationary stable state. An operating condition cₒ may occur when a number of iterations reach a threshold specified by the operating environment.

With respect to the computational model of the scenario simulator 116, for a next step (e.g., step [9]), the scenario simulator 116 may initialize, for the independent unified scenario constraint c∈C_{if}⁻, the following parameters:
a_{c}←0//Number of state transitions to reach goal state
β_{c}←0//Sizes of encodings of transition enabling conditions evaluated while reaching goal state
γ_{c}+0//Number of output state variables obtaining value assignments state during transitions

With respect to the computational model of the scenario simulator 116, for a next step (e.g., step [10]), in order to perform state transitions, the scenario simulator 116 may determine, for a current state of the OAEs in the sub-metaverse, if there exists at least one enabled transition (e.g., an outgoing edge with transition condition in that state being true).

With respect to the computational model of the scenario simulator 116, for a next step (e.g., step [11]), for all those OAEs for which enabled transitions exist, the state transitions may be executed in-parallel.

With respect to the computational model of the scenario simulator 116, for a next step (e.g., step [12]), after execution of state transitions, the scenario simulator 116 may include values of output state variables that have value assignments during these state transitions in a list of observed variables. For the example of FIG. 6, a list of observed variables is RainDepth, SupplyRaw, SupplyPro, and Operations.

With respect to a computational model of the scenario simulator 116, for a next step (e.g., step [13]), the scenario simulator 116 may update the following parameters:
α_{c}←α_{c}+Number of state transitions from step [11]
β_{c}←β_{c}+Sizes of encoding of transition enabling conditions assessed in step
γ_{c}←γ_{c}+Number of output state variables getting value assignments in step [12]

With respect to the aforementioned step [12], the scenario simulator 116 may analyze operating condition cₒ by comparing currently finished iterations with the threshold specified by the operating environment. If operating condition cₒ is true, the scenario simulator 116 may terminate the simulation process by setting flag Terminate=TRUE. The scenario simulator 116 may further communicate the list of observed variables, and the value of the flag Terminate to the goal analyzer 120.

With respect to the aforementioned step [13], if Terminate=FALSE, the scenario simulator 116 may evaluate stationarity condition cₛ by comparing a similarity of a current state with previous k≥1 states for each of the OAEs in the sub-metaverse. If for all OAEs, the scenario simulator 116 determines that their states are not changing significantly after state transitions (e.g., step [10]]), the scenario simulator 116 may flag the state as a stationary state of the sub-metaverse. Further, the scenario simulator 116 may terminate the simulation process by setting flag Terminate=TRUE, and communicate the termination to the goal analyzer 120.

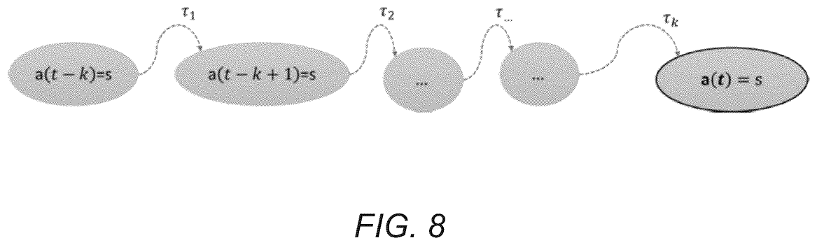

FIG. 8 illustrates state transition details to illustrate operation of the apparatus 100, in accordance with an example of the present disclosure.

Referring to FIG. 8, with respect to the aforementioned step [13], in iteration t, OAE α is in a stationary state if the following condition holds. In FIG. 8, the entity α reaches stationary state s at time-point t−k and remains in this state for the next k time-points.

a(t−k)→^{τ}^{₁} . . . →^{τ}^{ₖ}a(t)

such that

a(t−k)= . . . =a(t)=s Equation (5)

Referring again to FIG. 1, with respect to collaborative optimization, the scenario simulator 116 may minimize repeated exploration of the state space of OAEs for independent unified IF scenarios. For example, if two or more simulations reach a same state of an OAE and have the same transitions enabled in that state, further transitions may be executed only for the first simulation. Further, effects of all forthcoming transitions until the last state may be added to the subsequent simulations directly.

With respect to the computational model of the goal analyzer 120, at step [14], the goal analyzer 120 may evaluate if scenario goal g_{whatif} is satisfied over the values of the output state variables in the list of observed variables received from the scenario simulator 116. If the scenario goal is not satisfied, and Terminate=FALSE, the goal analyzer 120 may communicate back to the scenario simulator 116 to continue the simulation process for IF scenario c.

Alternatively, if the scenario goal is satisfied, the goal analyzer 120 may estimate overall energy cost of IF scenario c as follows:

energy_{c}=δ_{α}*α_{c}+δ_{β}+β_{c}+δ_{γ}*γ_{c} Equation (6)

### For Equation (6):

δ_{α}=Energy emission of executing a state transition;
δ_{β}=Energy emission of determining logical validity of a state transition enabling condition; and
δ_{γ}=Energy emission of assigning valuation to an output state variable.

If Terminate=FALSE, (e.g., scenario simulator 116 did not encounter termination conditions), the following flag is set (Terminate=TRUE), and communicated to the scenario simulator 116 to terminate the simulation process for IF scenario c, and start a simulation for a next unexplored IF scenario from C_{if}⁻.

With respect to the computational model of the goal analyzer 120, at step [15], once termination conditions are reached for all IF scenarios in C_{if}⁻, a selection may be made of those IF scenarios for which scenario goal g_{whatif} is satisfied in the final state of the simulation. In this regard, C_{if}*⊆C_{if}⁻ may be specified to be the set of these IF scenarios. Further, if C_{if}* is not empty, an IF scenario may be identified with a minimum energy cost by specifying c*∈C_{if}* with minimum energy Δ=energy_{c*}. In this regard, the following analysis is performed:

```
If (Δ ≤ Bounding Limit)
    Set M = {Goal State Reachable = True, Within Energy Bounds =
    True,
      Energy Cost = Δ, IF Scenario c*}
Else if (Δ > Bounding Limit)
    Set M = {Goal State Reachable = True, Within Energy Bounds =
    False,
      Energy Cost = Δ, IF Scenario c*}
Else if (C*_{if} = ∅) //i.e., none of the IF Scenarios can lead to Goal State
  Set M = {Goal State Reachable = False}
```

With respect to the computational model of the goal analyzer 120, at step [16], the goal analyzer 120 may communicate the value M to the ESG operating environment in the metaverse.

Next, with respect to quantification of energy cost optimization, with respect to scenario unification, in case each IF scenario would require approximately the same amount of computations during analysis, in comparison to non-unification based techniques, the apparatus 100 may achieve savings in computation by a factor of:

$$m = \frac{N}{n} \geq 1 \qquad Equation ( 7 )$$

For Equation (7), N=total number of IF scenarios, and n=independent unified scenarios.

With respect to sub-metaverse exploration, in comparison to determining energy bounded feasibility of deciding optimal IF scenarios transitioning to a goal state by exploring an unbounded metaverse, the apparatus 100 may limit exploration to a bounded sub-metaverse and thus avoid storage of copies of those organization avatar entities and semantic associations which have no or very low probability of being required during exploration. This would reduce storage and communication cost, for example, by a factor of:

$$u = \frac{{S}_{Metaverse}}{{s}_{submeta}} >> 1 \qquad Equation ( 8 )$$

For Equation (8), S_{Metaverse}=total number of organization avatar entities in the metaverse, and s_{submeta}=number of organization avatar entities and their associations as determined by the What-IF sub-metaverse generator 112.

If an energy conversion factor for computation is e_{comp} (e.g., e_{comp} Kw energy is emitted by metaverse for executing each unit of computations), and energy conversion factor for storage is e_{storage} (e.g., e_{storage} Kw energy is emitted by the metaverse managing process for each unit of data storage), then total energy cost minimization using the apparatus 100 may be determined as follows:

$$Δ = m + \frac{m \partial ( u - 1 )}{C + \partial } \qquad Equation ( 9 )$$

$$\partial = {e}_{s / c} {s}_{submeta}$$

$${e}_{s / c} = \frac{{e}_{storage}}{{e}_{comp}}$$

For Equation (9), C=average number of computations required for one IF scenario.

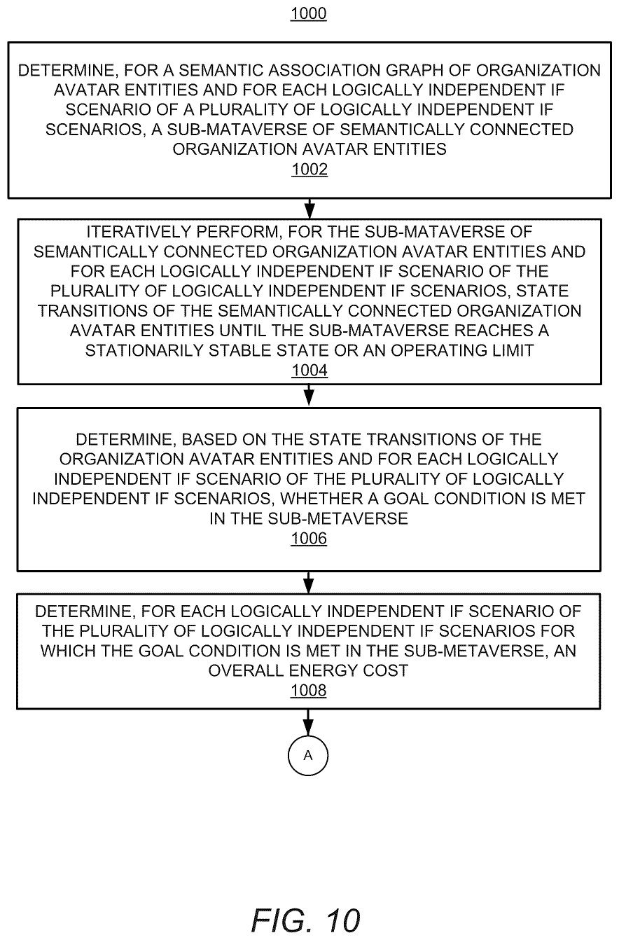

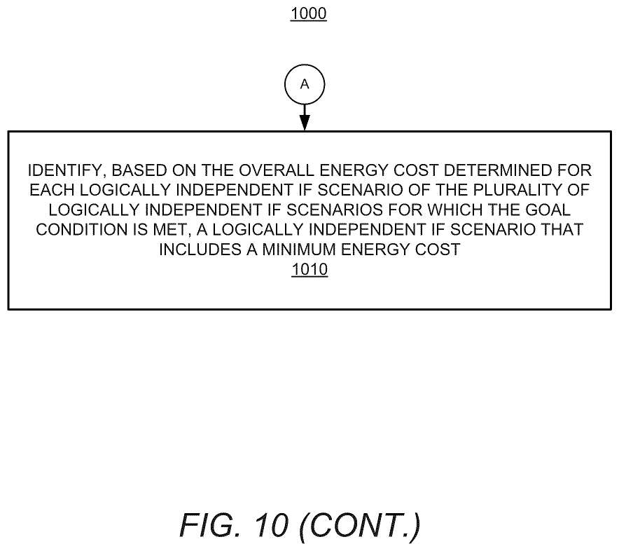

FIGS. 9-11 respectively illustrate an example block diagram 900, a flowchart of an example method 1000, and a further example block diagram 1100 for energy cost reduction of metaverse operations, according to examples. The block diagram 900, the method 1000, and the block diagram 1100 may be implemented on the apparatus 100 described above with reference to FIG. 1 by way of example and not of limitation. The block diagram 900, the method 1000, and the block diagram 1100 may be practiced in other apparatus. In addition to showing the block diagram 900, FIG. 9 shows hardware of the apparatus 100 that may execute the instructions of the block diagram 900. The hardware may include a processor 902, and a memory 904 storing machine readable instructions that when executed by the processor cause the processor to perform the instructions of the block diagram 900. The memory 904 may represent a non-transitory computer readable medium. FIG. 10 may represent an example method for energy cost reduction of metaverse operations, and the steps of the method. FIG. 11 may represent a non-transitory computer readable medium 1102 having stored thereon machine readable instructions to provide energy cost reduction of metaverse operations according to an example. The machine readable instructions, when executed, cause a processor 1104 to perform the instructions of the block diagram 1100 also shown in FIG. 11.

The processor 902 of FIG. 9 and/or the processor 1104 of FIG. 11 may include a single or multiple processors or other hardware processing circuit, to execute the methods, functions and other processes described herein. These methods, functions and other processes may be embodied as machine readable instructions stored on a computer readable medium, which may be non-transitory (e.g., the non-transitory computer readable medium 1102 of FIG. 11), such as hardware storage devices (e.g., RAM (random access memory), ROM (read only memory), EPROM (erasable, programmable ROM), EEPROM (electrically erasable, programmable ROM), hard drives, and flash memory). The memory 904 may include a RAM, where the machine readable instructions and data for a processor may reside during runtime.

Referring to FIGS. 1-9, and particularly to the block diagram 900 shown in FIG. 9, the memory 904 may include instructions 906 to generate a unified model of What-IF scenarios 104 by unifying logically connected IF scenarios (e.g., from an input including the IF scenarios 134), and identifying, for the unified logically connected IF scenarios, logically independent IF scenarios.

The processor 902 may fetch, decode, and execute the instructions 908 to generate a semantic association graph 108 of organization avatar entities 110.

The processor 902 may fetch, decode, and execute the instructions 910 to determine, for the semantic association graph 108 and for each logically independent IF scenario of the logically independent IF scenarios, a sub-metaverse 114 of semantically connected organization avatar entities.

The processor 902 may fetch, decode, and execute the instructions 912 to iteratively perform, for the sub-metaverse 114 of semantically connected organization avatar entities and for each logically independent IF scenario of the logically independent IF scenarios, state transitions of the semantically connected organization avatar entities until the sub-metaverse reaches a stationarily stable state or an operating limit.

The processor 902 may fetch, decode, and execute the instructions 914 to determine, based on the state transitions of the organization avatar entities and for each logically independent IF scenario of the logically independent IF scenarios, whether a goal condition 118 is met in the sub-metaverse 114.

The processor 902 may fetch, decode, and execute the instructions 916 to determine, for each logically independent IF scenario of the logically independent IF scenarios for which the goal condition 118 is met in the sub-metaverse 114, an overall energy cost 122.

The processor 902 may fetch, decode, and execute the instructions 918 to identify, based on the overall energy cost 122 determined for each logically independent IF scenario of the logically independent IF scenarios for which the goal condition 118 is met, a logically independent IF scenario 124 that includes a minimum energy cost 126.

The processor 902 may fetch, decode, and execute the instructions 920 to control, for an organization entity 130, an operation 132 based on the logically independent IF scenario 124 that includes the minimum energy cost 126.

Referring to FIGS. 1-8 and 10, and particularly FIG. 10, for the method 1000, at block 1002, the method may include determining, for a semantic association graph of organization avatar entities and for each logically independent IF scenario of a plurality of logically independent IF scenarios, a sub-metaverse of semantically connected organization avatar entities.

At block 1004, the method may include iteratively performing, for the sub-metaverse of semantically connected organization avatar entities and for each logically independent IF scenario of the plurality of logically independent IF scenarios, state transitions of the semantically connected organization avatar entities until the sub-metaverse reaches a stationarily stable state or an operating limit.

At block 1006, the method may include determining, based on the state transitions of the organization avatar entities and for each logically independent IF scenario of the plurality of logically independent IF scenarios, whether a goal condition is met in the sub-metaverse.

At block 1008, the method may include determining, for each logically independent IF scenario of the plurality of logically independent IF scenarios for which the goal condition is met in the sub-metaverse, an overall energy cost.

At block 1010, the method may include identifying, by the at least one hardware processor, based on the overall energy cost determined for each logically independent IF scenario of the plurality of logically independent IF scenarios for which the goal condition is met, a logically independent IF scenario that includes a minimum energy cost.

Referring to FIGS. 1-8 and 11, and particularly FIG. 11, for the block diagram 1100, the non-transitory computer readable medium 1102 may include instructions 1106 to determine, for each IF scenario of a plurality of IF scenarios associated with organization avatar entities for a metaverse, an overall energy cost.

The processor 1104 may fetch, decode, and execute the instructions 1108 to identify, based on the overall energy cost determined for each IF scenario of the plurality of IF scenarios, an IF scenario that includes a minimum energy cost.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. An energy cost reduction of metaverse operations apparatus comprising:
at least one hardware processor;
a scenario unification and partitioning analyzer, executed by the at least one hardware processor, to generate a unified model of What-IF scenarios by:
unifying logically connected IF scenarios; and
identifying, for the unified logically connected IF scenarios, logically independent IF scenarios;
a graph generator, executed by the at least one hardware processor, to generate a semantic association graph of organization avatar entities;
a What-IF sub-metaverse generator, executed by the at least one hardware processor, to determine, for the semantic association graph and for each logically independent IF scenario of the logically independent IF scenarios, a sub-metaverse of semantically connected organization avatar entities;
a scenario simulator, executed by the at least one hardware processor, to:
iteratively perform, for the sub-metaverse of semantically connected organization avatar entities and for each logically independent IF scenario of the logically independent IF scenarios, state transitions of the semantically connected organization avatar entities until the sub-metaverse reaches a stationarily stable state or an operating limit; and
determine, based on the state transitions of the organization avatar entities and for each logically independent IF scenario of the logically independent IF scenarios, whether a goal condition is met in the sub-metaverse;
a goal analyzer, executed by the at least one hardware processor, to:
determine, for each logically independent IF scenario of the logically independent IF scenarios for which the goal condition is met in the sub-metaverse, an overall energy cost; and
identify, based on the overall energy cost determined for each logically independent IF scenario of the logically independent IF scenarios for which the goal condition is met, a logically independent IF scenario that includes a minimum energy cost; and
an organization entity controller, executed by the at least one hardware processor, to control, for an organization entity, an operation based on the logically independent IF scenario that includes the minimum energy cost.

2. The energy cost reduction of metaverse operations apparatus according to claim 1, wherein the goal analyzer is executed by the at least one hardware processor to determine, for each logically independent IF scenario of the logically independent IF scenarios for which the goal condition is met in the sub-metaverse, a number of state transitions to reach a goal state.

3. The energy cost reduction of metaverse operations apparatus according to claim 1, wherein the goal analyzer is executed by the at least one hardware processor to determine, for each logically independent IF scenario of the logically independent IF scenarios for which the goal condition is met in the sub-metaverse, sizes of encodings of transition enabling conditions.

4. The energy cost reduction of metaverse operations apparatus according to claim 1, wherein the goal analyzer is executed by the at least one hardware processor to determine, for each logically independent IF scenario of the logically independent IF scenarios for which the goal condition is met in the sub-metaverse, a number of operations that involve state variables during transitions to reach a goal state.

5. The energy cost reduction of metaverse operations apparatus according to claim 1, wherein the scenario unification and partitioning analyzer is executed by the at least one hardware processor to identify, for the unified logically connected IF scenarios, logically independent IF scenarios by:
retaining, from each cluster of a plurality of clusters of the unified logically connected IF scenarios, a single IF scenario.

6. The energy cost reduction of metaverse operations apparatus according to claim 1, wherein the goal analyzer is executed by the at least one hardware processor to determine, for each logically independent IF scenario of the logically independent IF scenarios for which the goal condition is met in the sub-metaverse, the overall energy cost as a function of at least one of:
energy emission of executing a state transition;
energy emission of determining logical validity of a state transition enabling condition; or
energy emission of assigning a value to an output state variable.

7. The energy cost reduction of metaverse operations apparatus according to claim 1, wherein the goal analyzer is executed by the at least one hardware processor to:
compare the minimum energy cost to a bounding limit; and
based on a determination that the minimum energy cost is less than the bounding limit, identify the logically independent IF scenario as including the minimum energy cost that is less than the bounding limit.

8. The energy cost reduction of metaverse operations apparatus according to claim 1, wherein the goal analyzer is executed by the at least one hardware processor to:
compare the minimum energy cost to a bounding limit; and
based on a determination that the minimum energy cost is greater than the bounding limit, identify the logically independent IF scenario as including the minimum energy cost that is greater than the bounding limit.

9. A method for energy cost reduction of metaverse operations, the method comprising:
determining, by at least one hardware processor, for a semantic association graph of organization avatar entities and for each logically independent IF scenario of a plurality of logically independent IF scenarios, a sub-metaverse of semantically connected organization avatar entities;
iteratively performing, by the at least one hardware processor, for the sub-metaverse of semantically connected organization avatar entities and for each logically independent IF scenario of the plurality of logically independent IF scenarios, state transitions of the semantically connected organization avatar entities until the sub-metaverse reaches a stationarily stable state or an operating limit;
determining, by the at least one hardware processor, based on the state transitions of the organization avatar entities and for each logically independent IF scenario of the plurality of logically independent IF scenarios, whether a goal condition is met in the sub-metaverse;
determining, by the at least one hardware processor, for each logically independent IF scenario of the plurality of logically independent IF scenarios for which the goal condition is met in the sub-metaverse, an overall energy cost; and
identifying, by the at least one hardware processor, based on the overall energy cost determined for each logically independent IF scenario of the plurality of logically independent IF scenarios for which the goal condition is met, a logically independent IF scenario that includes a minimum energy cost.

10. The method according to claim 9, further comprising controlling, by the at least one hardware processor, for an organization entity, an operation based on the logically independent IF scenario that includes the minimum energy cost.

11. The method according to claim 9, further comprising determining, by the at least one hardware processor, for each logically independent IF scenario of the plurality of logically independent IF scenarios for which the goal condition is met in the sub-metaverse, a number of state transitions to reach a goal state.

12. The method according to claim 9, further comprising determining, by the at least one hardware processor, for each logically independent IF scenario of the plurality of logically independent IF scenarios for which the goal condition is met in the sub-metaverse, sizes of encodings of transition enabling conditions.

13. The method according to claim 9, further comprising determining, by the at least one hardware processor, for each logically independent IF scenario of the plurality of logically independent IF scenarios for which the goal condition is met in the sub-metaverse, a number of operations that involve state variables during transitions to reach a goal state.

14. The method according to claim 9, further comprising determining, by the at least one hardware processor, for each logically independent IF scenario of the plurality of logically independent IF scenarios for which the goal condition is met in the sub-metaverse, the overall energy cost as a function of at least one of:
energy emission of executing a state transition;
energy emission of determining logical validity of a state transition enabling condition; or
energy emission of assigning a value to an output state variable.

15. The method according to claim 9, further comprising:
comparing, by the at least one hardware processor, the minimum energy cost to a bounding limit; and
based on a determination that the minimum energy cost is less than the bounding limit, identifying, by the at least one hardware processor, the logically independent IF scenario as including the minimum energy cost that is less than the bounding limit.

16. A non-transitory computer readable medium having stored thereon machine readable instructions, the machine readable instructions, when executed by at least one hardware processor, cause the at least one hardware processor to:
determine, for each IF scenario of a plurality of IF scenarios associated with organization avatar entities for a metaverse, an overall energy cost; and
identify, based on the overall energy cost determined for each IF scenario of the plurality of IF scenarios, an IF scenario that includes a minimum energy cost.

17. The non-transitory computer readable medium according to claim 16, wherein the machine readable instructions, when executed by the at least one hardware processor, further cause the at least one hardware processor to:
control, for an organization entity, an operation based on the IF scenario that includes the minimum energy cost.

18. The non-transitory computer readable medium according to claim 16, wherein the machine readable instructions, when executed by the at least one hardware processor, further cause the at least one hardware processor to:
determine, for a semantic association graph of the organization avatar entities and for each logically independent IF scenario of the plurality of IF scenarios that represent a plurality of logically independent IF scenarios, a sub-metaverse of semantically connected organization avatar entities.

19. The non-transitory computer readable medium according to claim 18, wherein the machine readable instructions, when executed by the at least one hardware processor, further cause the at least one hardware processor to:
iteratively perform, for the sub-metaverse of semantically connected organization avatar entities and for each logically independent IF scenario of the plurality of logically independent IF scenarios, state transitions of the semantically connected organization avatar entities until the sub-metaverse reaches a stationarily stable state or an operating limit.

20. The non-transitory computer readable medium according to claim 19, wherein the machine readable instructions, when executed by the at least one hardware processor, further cause the at least one hardware processor to:
determine, based on the state transitions of the organization avatar entities and for each logically independent IF scenario of the plurality of logically independent IF scenarios, whether a goal condition is met in the sub-metaverse;
determine, for each logically independent IF scenario of the plurality of logically independent IF scenarios for which the goal condition is met in the sub-metaverse, the overall energy cost; and
identify, based on the overall energy cost determined for each logically independent IF scenario of the plurality of logically independent IF scenarios for which the goal condition is met, a logically independent IF scenario that includes the minimum energy cost.
